(19) United States
(12) Patent Application Publication
(10) Pub. No.: US 2004/0017745 A1
(43) Pub. Date: Jan. 29, 2004

(54) Optical disc drive system for recording at a constant angular velocity

(76) Inventors: Daw-I Wang, Taipei Hsien (TW); Chih-Long Dai, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/065,765

(22) Filed: Nov. 18, 2002

(30) Foreign Application Priority Data
Jul. 25, 2002 (TW) 091116645

(51) Int. Cl. G11B 7/0045

(52) U.S. Cl. 369/47.35; 369/47.48

(57) ABSTRACT

An optical disc system for recoding data onto an optical disc while the optical disc is rotating at a constant angular velocity. The optical disc system includes a PLL for extracting a carrier frequency of a wobble signal outputted from an optical pick-up, a channel synthesizer electrically connected to the PLL for generating a channel clock according to the carrier frequency and a rotating factor of a spindle motor, a data encoder for encoding inputted data according to the channel clock, and a driving circuit for controlling the optical pick-up to record data onto the optical disc according to the encoded data.

### BACKGROUND OF THE INVENTION

1. Field of the Invention

The present invention relates to optical disc drive systems, and more particularly, the present invention provides an optical disc drive system for recording at a constant angular velocity.

2. Description of the Prior Art

Optical discs, in spite of their low cost, convenient size, and light weight, are actually able to store large quantities of data, and have already become the most common storage medium in today's modern information society. In particular, research and development of recordable optical discs already allows users to record their data to the optical discs at will, and has also made optical discs become one of the most important personal storage media of today. It is also a goal of modern information industry research and development to increase a reliability and efficiency of recording information to the optical disc. Currently, speeds of optical disc recorders are increasing rapidly, and latest technology recorders are able to record at speeds 30-40 times faster than their original counterparts. However, at such high speeds, many problems arise.

In compact disc recordable (CD-R) and compact disc rewriteable (CD-RW) systems, data is recorded according to density. An amount of information written over each unit length must meet a specification. Up to the present, CD-R and CD-RW recorders use a constant linear velocity (CLV) recording method, namely, controlling a spindle motor, which matches an optical pickup unit to the linear velocity of the optical disc, and then recording the data at the fixed frequency according to the linear velocity. However, owing to the development of higher speed recorders, the constant linear velocity is limited by the spindle motor.

Thus, current recording technology uses another, derived, constant linear velocity to enter high-speed operation. This technology is called Zone-CLV. Zone-CLV divides the optical disc into zones, and each zone is assigned a specific linear velocity. The velocities increase from the center of the disc outward. However, each time a boundary between zones is crossed, recording must be stopped, while the spindle motor changes speed, before data recording can continue. In the process, the spindle motor must be controlled very accurately, and this causes next-generation recording technology to become difficult to reach.

### SUMMARY OF INVENTION

Thus, it is an objective of the claimed invention to provide an optical disc recording system that is not limited by a spindle motor and eases control circuitry precision requirements.

Briefly, the claimed invention provides an optical disc system for recording data to an optical disc rotating at a constant angular velocity. The optical disc system has a spindle motor, an optical pickup unit, a phase-locked loop, a clock synthesizer, a data encoder, and an optical pickup unit driver circuit. The spindle motor rotates the optical disc at a constant angular velocity (CAV). The optical pickup unit accesses data on the optical disc and produces a wobble signal. The phase-locked loop (PLL) extracts a wobble signal carrier frequency from the wobble signal output by the optical pickup unit. The clock synthesizer is electrically connected to the PLL, and produces a channel clock conforming to the CAV, according to the carrier frequency output by the PLL and the operating speed of the spindle motor. The data encoder is used in accordance with the channel clock output by the clock synthesizer to encode incoming data and produce a corresponding data signal. The driver circuit is connected to the optical pickup unit, and is used for controlling the optical pickup unit according to a write strategy of the optical disc system and the data signal output by the data encoder.

It is an advantage of the claimed invention that while the optical disc system is operating at a constant angular velocity, because the spindle motor can stay at constant rotation speed, the spindle does not need to be accelerated or decelerated according to the rotation radius, resulting in greatly reducing the precision needed to control the spindle motor. In addition, the optical disc system also can obtain maximum recording efficiency since the spindle motor constantly maintains maximum rotation speed.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a diagram of an optical disc system, according to the present invention.

### DETAILED DESCRIPTION

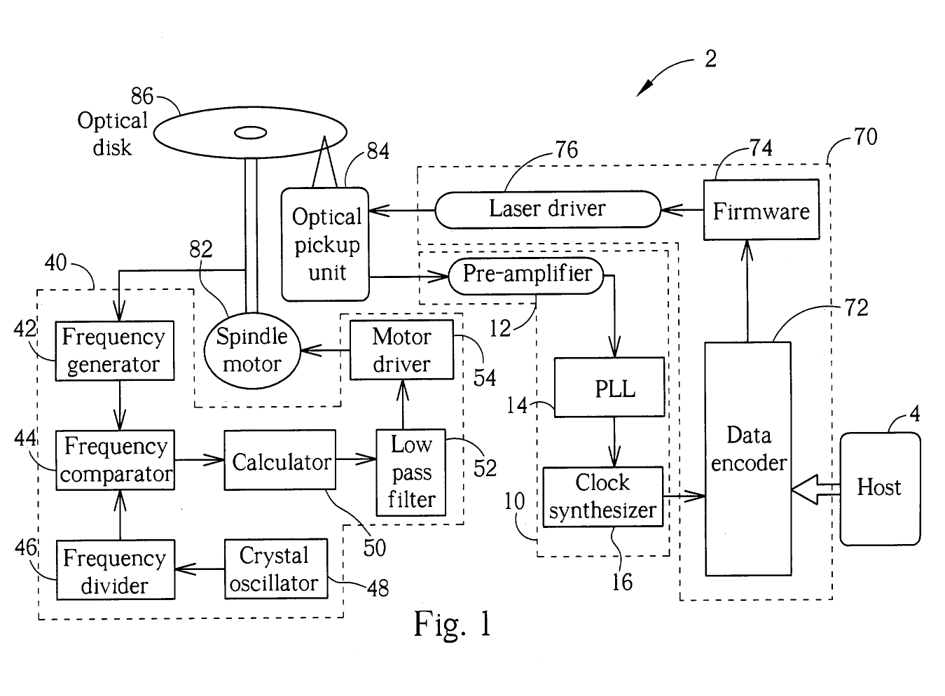

Please refer to FIG. 1, which is a diagram of an optical disc system 2 according to the present invention. The system 2 comprises a host 4, a first circuit 10, a second circuit 40, a third circuit 70, a spindle motor 82, and a laser optical pickup unit 84. The second circuit 40 is used to drive the motor at a fixed frequency, and the first circuit 10 is used to send a channel clock corresponding to a linear velocity of the optical disc system 2 to a data encoder 72 of the third circuit 70. The encoder 72, according to channel clock, encodes data from the host 4 to a data form that can be recorded by the optical disc system 2.

Please refer again to the first circuit 10. The first circuit 10 comprises a preamplifier 12, a phase-locked loop (PLL) 14, and a clock synthesizer 16. The preamplifier 12 is used to amplify a wobble signal sent from the laser optical pickup unit 84 for further processing. The wobble signal is then immediately input to the PLL 14. The wobble signal is an Archimedes spiral, and is stored on an absolute time in pre-groove (ATIP) of the optical disc through frequency shift key (FSK) modulation. Thus, by sending the signal to the PLL 14, the carrier frequency of the wobble signal can be extracted. The frequency is given by 22.05*n KHz, where “n” represents a linear multiplier of the optical disc drive rotation, and need not be an integer. The data is sent to the clock synthesizer 16, so that the clock synthesizer 16 can produce a channel clock at 4.3218*n MHz, where “n” is the linear multiplier mentioned above. And, as described above, the channel clock is for use by the encoder 72 as a reference clock when performing data encoding. The channel clock is also key in calculating a constant angular velocity (CAV) in the present invention. Because the multiplier “n” of the CAV changes with the movement of the optical pickup unit 84, by constantly updating the channel clock, the system 2 can ensure that the data produced by the data encoder 72 is correct when being recorded to the optical disc.

Please refer again to the second circuit 40 of FIG. 1. The second circuit 40 comprises a frequency generator 42, a frequency comparator 44, a frequency divider 46, a crystal oscillator 48, a motor driver circuit 54, a calculator 50, and a low-pass filter 52. The frequency generator 42 is electrically connected to the spindle motor 82 and produces six pulses for each turn of the motor 82. The frequency generator 42 produces a corresponding first signal with a change of rotation speed of the spindle motor 82. Meanwhile, the crystal oscillator 48 produces a fixed frequency and then sends the fixed frequency to the frequency divider 46 to produce a second signal where the frequency of the second signal is a frequency of an expected uniform rotation angular velocity. The first signal and the second signal are sent to the frequency comparator 44 for comparing, and the frequency comparator 44 sends the compared result to the calculator 50; the processed signal by the calculator 50 passes through the low-pass filter 52 for filtering the signal and then is sent to the motor driver circuit 54. The spindle motor 82 will be accelerated or decelerated by the motor driver circuit 54 according to the inputted signal. This means that if the frequency of the second signal produced by the frequency divider 46, i.e. the predetermined frequency corresponding to the spindle motor 82, is higher than the frequency of the rotating spindle motor 82 at that time, the motor driver circuit 54 is going to accelerate the rotation speed of the spindle motor 82. On the contrary, if the frequency of the second signal produced by the frequency divider 46 is lower than the frequency of the rotating spindle motor 82 at that time, the motor driver circuit 54 is going to decelerate the rotation speed of the spindle motor 82.

Please refer again to the third circuit 70 of FIG. 1. The third circuit 70 comprises the data encoder 72, a firmware 74, and a laser driver 76. The data encoder 70 electrically connected to the host 4 and the clock synthesizer 16 of the first circuit 10 constantly gets the latest channel clock from the clock synthesizer 16. Hence, the data encoder 72 is capable of constantly encoding the inputted data from the host 4 by the latest channel clock. Then, the encoded data transforms into a proper pulse train based on a write strategy stored in the firmware 74 to conduct the laser driver 76 to control the laser optical pickup unit 84 for recording to the optical disc 86.

While optical disc system 2 is operating at a constant angular velocity, because the spindle motor 82 can be kept at a constant rotation speed, the spindle motor 82 does not need to be accelerated or decelerated according to the rotation radius, resulting in greatly reducing the precision required for controlling the spindle motor 82, which is a limitation of the constant-linear-velocity-operated spindle motor 82. In addition, the optical disc system 2 also can obtain maximum recording efficiency when the spindle motor 82 is constantly rotated at its maximum rotation speed.

Those skilled in the art will readily observe that numerous modifications and alterations of the system may be made while retaining the teachings of the invention. Accordingly, the above disclosure should be construed as limited only by the metes and bounds of the appended claims.

What is claimed is:

1. An optical disc system for recording data to an optical disc rotating at a constant angular velocity, the optical disc system comprising:
a spindle motor for rotating the optical disc at a constant angular velocity (CAV);
an optical pickup unit for accessing data on the optical disc and producing a wobble signal;
a phase-locked loop (PLL) for extracting a wobble signal carrier frequency from the wobble signal output by the optical pickup unit;
a clock synthesizer electrically connected to the PLL for producing a channel clock conforming to the CAV according to the carrier frequency output by the PLL and the operating speed of the spindle motor;
a data encoder for being used in accordance with the channel clock output by the clock synthesizer to encode incoming data and produce a corresponding data signal; and
an optical pickup unit driver circuit connected to the optical pickup unit for controlling the optical pickup unit according to a write strategy of the optical disc system and the data signal output by the data encoder.

2. The optical disc system of claim 1 further comprising a pre-amplifier electrically connected to the PLL and the optical pickup unit for amplifying the wobble signal output by the optical pickup unit.

3. The optical disc system of claim 1 further comprising:
a frequency generator connected to the spindle motor for producing a first signal according to a rotation speed of the spindle motor;
a crystal oscillator for producing a fixed clock;
a frequency divider connected to the crystal oscillator for dividing the frequency of the inputted fixed clock to produce a second signal;
a frequency comparator connected to the frequency generator and the frequency divider for comparing the first signal and the second signal so as to produce a control signal; and
a motor driver circuit for driving the spindle motor to rotate the optical disc according to the control signal.

4. The optical disc system of claim 1 being an optical disc recorder.

5. The optical disc system of claim 1 wherein the optical pickup unit is a laser pickup.

6. A method of using an optical disc system for recording data to an optical disc rotating at a constant angular velocity comprising:
providing a spindle motor for rotating the optical disc at a constant angular velocity (CAV);
providing an optical pickup unit for accessing data on the optical disc and producing a wobble signal;
providing a phase-locked loop (PLL) for extracting a wobble signal carrier frequency from the wobble signal output by the optical pickup unit;
providing a clock synthesizer electrically connected to the PLL for producing a channel clock conforming to the CAV according to the carrier frequency output by the PLL and the operating speed of the spindle motor;
providing a data encoder for being used in accordance with the channel clock output by the clock synthesizer to encode incoming data and produce a corresponding data signal; and
providing an optical pickup unit driver circuit connected to the optical pickup unit for controlling the optical pickup unit according to a write strategy of the optical disc system and the data signal output by the data encoder.

7. The method of claim 6 further comprising a pre-amplifier electrically connected to the PLL and the optical pickup unit for amplifying the wobble signal output by the optical pickup unit.

8. The method of claim 6 further comprising:
providing a frequency generator connected to the spindle motor for producing a first signal according to a rotation speed of the spindle motor;
providing a crystal oscillator for producing a fixed clock;
providing a frequency divider connected to the crystal oscillator for dividing the frequency of the inputted fixed clock to produce a second signal;
providing a frequency comparator connected to the frequency generator and the frequency divider for comparing the first signal and the second signal so as to produce a control signal; and
providing a motor driver circuit for driving the spindle motor to rotate the optical disc according to the control signal.

9. The method of claim 6 wherein the optical disc system is an optical disc recorder.

10. The method of claim 6 wherein the optical pickup unit is a laser pickup.
